(19) United States
(12) Patent Application Publication
(10) Pub. No.: US 2014/0125128 A1
(43) Pub. Date: May 8, 2014

(54) POWER REDUNDANCY APPARATUS FOR RACK-MOUNTED SERVER

(71) Applicant: ELECTRONICS AND TELECOMMUNICATIONS RESEARCH INSTITUTE, Daejeon (KR)

(72) Inventors: Won-Ok KWON, Daejeon (KR); Hag Young KIM, Daejeon (KR)

(21) Appl. No.: 13/890,370

(22) Filed: May 9, 2013

(30) Foreign Application Priority Data
Nov. 7, 2012 (KR) 10-2012-0125530

(51) Int. Cl. H02J 9/04

(52) U.S. Cl. CPC H02J 9/04
USPC 307/23

(57) ABSTRACT

A power redundancy apparatus for a rack-mounted server may include a first server that includes first and second connectors connected in parallel to the output side of a first PSU, a second server that includes third and fourth connectors connected in parallel to the output side of a second PSU, and a power connection cable for coupling any one of the first and the third connectors, the second and the fourth connectors, the first and the fourth connectors, and the second and the third connectors.

### RELATED APPLICATION(S)

This application claims the benefit of Korean Patent Application No. 10-2012-0125530, filed on Nov. 7, 2012, which is hereby incorporated by references as if fully set forth herein.

### FIELD OF THE INVENTION

The present invention relates to an efficient power redundancy apparatus for a rack-mounted server and, more particularly, to a power redundancy apparatus for a rack-mounted server which does not need an additional Power Supply Unit (PSU) in order to be prepared for power failures by sharing the supply of power between adjacent rack-mounted servers mounted in a rack.

### BACKGROUND OF THE INVENTION

As is well known, expensive mainframes used as servers in data centers are gradually being replaced by cheap rack-mounted 1U or 2U servers. The amount of power consumed by such servers is gradually decreasing with the development of semiconductor device technology, such as CPUs and memory, as well as operating system power management technology. In particular, power consumption by a server in an idle state, in which a server does not operate, has been greatly reduced. In contrast, the power efficiency and load capacity of a PSU mounted in such a server have gradually increased.

In general, a rack-mounted server is configured to have data storage disposed in the front thereof, a main board disposed at the center thereof, and a PSU and other I/O connectors disposed at the rear thereof.

That is, a PSU receives external AC power and generates DC output voltage (e.g., one DC voltage or a plurality of DC voltages) used by a server. Control signals, such as a power-on signal PSON, a power state signal PSOK, and a load share signal, are input to and output from the PSU. If a PMBUS for power monitoring is used in the PSU, corresponding signals are sent to and received from a main board.

Here, the output capacity of the PSU must be greater than the rated maximum load P_{MAX} used by the server. In general, the output capacity of the PSU is 20% to 30% greater than that of the server. The rated maximum load P_{MAX} of the server can be measured based on power consumption in a maximum load state when all devices are mounted in the server.

However, the maximum load of a server that is used in practice is much smaller than the rated maximum load P. This is because not all storage devices, memory, cooling fans, and I/O devices are mounted in a server that is used in practice. Furthermore, since the PSU has an output capacity that is 20% to 30% greater than the rated maximum load P_{MAX} for power stability, the actual capacity P_{PSU} of the PSU is at least twice the maximum consumption power P_{S}_{_{—}}_{MAX} of the server.

For example, in a common 1U˜2U server, the capacity of a PSU is 700 W or more, but the actual maximum power consumption of the server is less than 300 W. When the server is in an idle state, power consumption is less than 100 W.

In general, a hot-pluggable PSU or a fixed PSU is disposed at the back of a server, and two PSUs, PSU#1 and PSU#2, are mounted in the server to realize power redundancy in order to stabilize the supply of power.

Accordingly, both PSUs supply power to the server. If one of the two PSUs fails to supply power, the other PSU continues to supply power to the server in order to prevent problems occurring due to the shortage of power. In this supplementary power supply method, power is supplied to a server in an N+1 form (wherein N=1, 2, 3, and +1 is the number of added PSUs); alternatively, power redundancy is possible in other forms.

### SUMMARY OF THE INVENTION

The conventional power redundancy apparatus using a supplementary PSU is advantageous in that the stability of the supply of power is increased, but is disadvantageous in that the cost per server is increased because an additional PSU for power redundancy must be mounted in each server.

Furthermore, a conventional power redundancy apparatus is disadvantageous in that unnecessary power consumption is increased because one or more PSUs are additionally driven when additional power is used.

In accordance with an aspect of the present invention, there is provided a power redundancy apparatus for a rack-mounted server on which a plurality of servers is freely loaded, including a first server that includes first and second connectors connected in parallel to the output side of a first PSU, a second server that includes third and fourth connectors connected in parallel to the output side of a second PSU, and a power connection cable for coupling the first and the third connectors, the second and the fourth connectors, the first and the fourth connectors, or the second and the third connectors.

The first server may include the first PSU, a first power backplane board equipped with the first and the second connectors, and a first server main board, on which a main PCB driven by power supplied by the first PSU or the second PSU is mounted.

The second server may include the second PSU, a second power backplane board equipped with the third and the fourth connectors, and a second server main board, on which a main PCB driven by power supplied by the second PSU or the first PSU is mounted.

Each of the first and the second power backplane board may couple an input signal, a control signal, and a load sharing signal in parallel between the first and the second servers.

The power connection cable may couple any one of the first and the third connectors, the second and the fourth connectors, the first and the fourth connectors, and the second and the third connectors in a plug-in form.

In accordance with another aspect of the present invention, there is provided a power redundancy apparatus for a rack-mounted server on which a plurality of servers is freely loaded, including a first server that includes first and second connectors connected in parallel to the output side of a first PSU, a second server that includes third and fourth connectors, and a power connection cable for coupling the first and the third connectors, the second and the fourth connectors, the first and the fourth connectors, or the second and the third connectors.

The first server may include the first PSU, a first power backplane board equipped with the first and the second connectors, and a first server main board on which a main PCB driven by power supplied by the first PSU is mounted.

The second server may include a second power backplane board equipped with the third and the fourth connectors and a second server main board on which a main PCB driven by power supplied by the first PSU is mounted.

Each of the first and the second power backplane board may couple an input signal, a control signal, and a load sharing signal in parallel between the first and the second servers.

The power connection cable may couple the first and the third connectors, the second and the fourth connectors, the first and the fourth connectors, or the second and the third connectors in a plug-in form.

### BRIEF DESCRIPTION OF THE DRAWINGS

The objects and features of the present invention will become apparent from the following description of embodiments given in conjunction with the accompanying drawings, in which:

FIG. 1 shows the rear construction of the power redundancy apparatus for a rack-mounted server in accordance with an embodiment of the present invention;

FIG. 2 shows the structure of the main board and the power backplane of a rack-mounted server for illustrating the sharing of a power bus between servers;

FIG. 3 is a diagram showing the parallel connection arrangement of a power backplane board;

FIGS. 4a to 4c are diagrams showing examples in which the power redundancy apparatus in accordance with the present invention is applied to various numbers of rack-mounted servers for a power supply redundancy mode;

FIGS. 5a to 5c are diagrams showing examples in which the power redundancy apparatus in accordance with the present invention is applied to various numbers of rack-mounted servers for a high-efficiency mode; and

FIGS. 6a and 6b are graphs showing the results of a comparison between load-efficiency operating points in a common server and a high-efficiency mode server.

### DETAILED DESCRIPTION OF THE EMBODIMENTS

Hereinafter, embodiments of the present invention will be described in detail with reference to the accompanying drawings, which form a part hereof.

First, the merits and characteristics of the present invention and the methods for achieving the merits and characteristics thereof will become more apparent from the following embodiments taken in conjunction with the accompanying drawings. However, the present invention is not limited to the disclosed embodiments, but may be implemented in various ways. The embodiments are provided to complete the disclosure of the present invention and to enable a person having ordinary skill in the art to understand the scope of the present invention. The present invention is defined by the claims.

Furthermore, in describing the embodiments of the present invention, a detailed description of known functions or constructions related to the present invention will be omitted if it is deemed that such description would make the gist of the present invention unnecessarily vague. Furthermore, terms to be described later are defined by taking the functions of embodiments of the present invention into consideration, and may be different according to the operator's intention or usage. Accordingly, the terms should be defined based on the overall contents of the specification.

### Embodiment 1

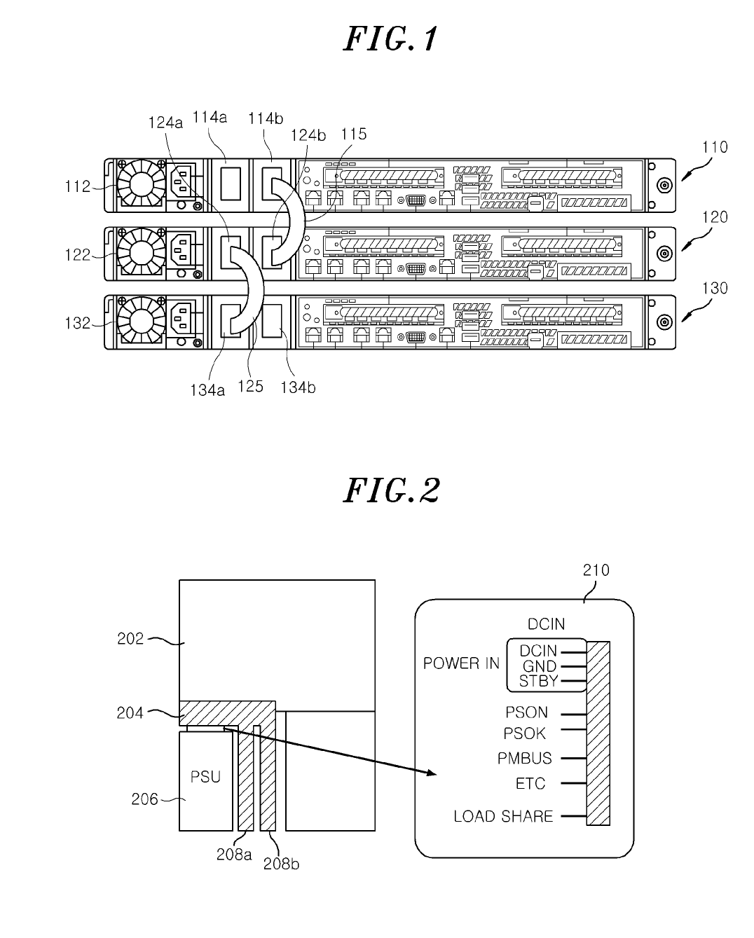

FIG. 1 shows the rear construction of the power redundancy apparatus for a rack-mounted server in accordance with an embodiment of the present invention. The power redundancy apparatus can include three first to third rack-mounted servers 110, 120, and 130.

Referring to FIG. 1, the first rack-mounted server 110 can include a first PSU 112, first and second connectors 114a and 114b, and a first server main board (not shown), on which a main PCB is mounted. The second rack-mounted server 120 can include a second PSU 122, third and fourth connectors 124a and 124b, and a second server main board (not shown), on which a main PCB is mounted. The third rack-mounted server 130 can include a third PSU 132, fifth and sixth connectors 134a and 134b, and a third server main board (not shown), on which a main PCB is mounted.

Furthermore, the second connector 114b of the first rack-mounted server 110 and the fourth connector 124b of the second rack-mounted server 120, which is adjacent to the second connector 114b, are electrically connected (or coupled) by a power connection cable 115. The third connector 124a of the second rack-mounted server 120 and the fifth connector 134a of the third rack-mounted server 130, which is adjacent to the third connector 124a, are electrically connected (or coupled) by a power connection cable 125. Here, the power connection cables 115 and 125 for electrically coupling the second connector 114b and the fourth connector 124b and the third connector 124a and the fifth connector 134a, respectively, can be coupled in a plug-in form.

In the power redundancy apparatus in accordance with the present invention, unlike the construction in which the second and the fourth connectors 114b and 124b are coupled by the power connection cable 115, any combination of the first and the third connectors 114a and 124a, the first and the fourth connectors 114a and 124b, and the second and the third connectors 114b and 124a may be coupled by the power connection cable 115. Furthermore, unlike the construction in which the third and the fifth connectors 124a and 134a are coupled by the power connection cable 125, any combination of the fourth and the sixth connectors 124b and 134b, the third and the sixth connectors 124a and 134b, and the fourth and the fifth connectors 124b and 134a may be coupled by the power connection cable 125.

Furthermore, a rack-mounted server having chain coupling using power connection cables can include, for example, a server main board 202, on which a main PCB (not shown) driven by power supplied by a PSU is mounted, a power backplane board 204 equipped with a pair of connectors 208a and 208b, and a PSU 206, as shown in FIG. 2. Only one PSU is mounted on a power backplane 210 for the PSU 206. The power backplane 210 has input and output terminals for control signals, such as DCIN, ground GND, standby power STBY, a power-on signal PSON, a power state signal PSOK, PMBUS, other signals Etc., and a load sharing signal Load Share. Here, if the PMBUS is used, corresponding signals are exchanged with a power backplane connector.

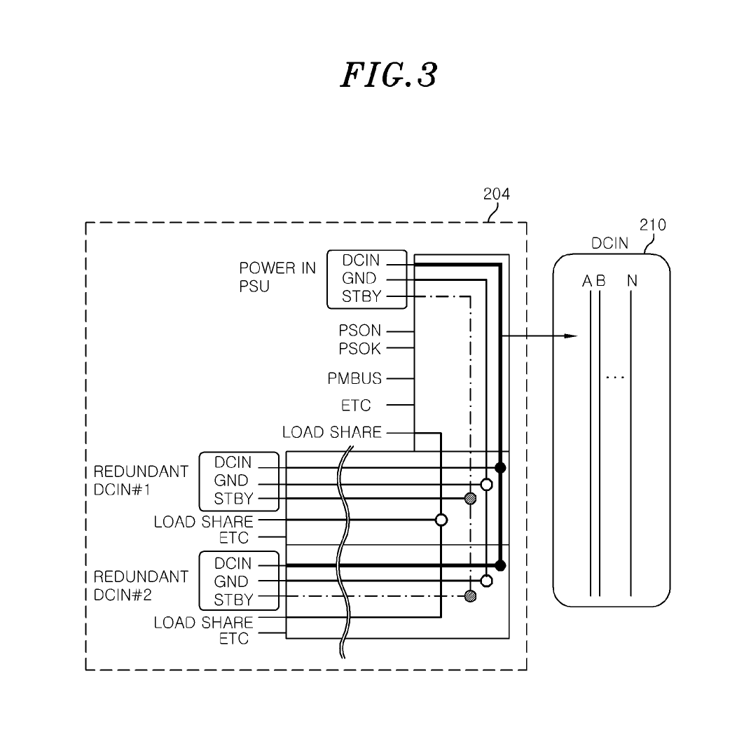

Furthermore, each of the power connection cables 115 and 125 can couple the control signals, such as DCIN, GND, STBY, PSON, PSOK, PMBUS, Etc., and Load Share, in parallel (i.e., parallel connection between rack-mounted servers), as shown in FIG. 3. The control signals are input to and output from (or exchanged with) the controller (not shown) of a rack-mounted server. Here, DC voltage having +12 V or several tens to several hundreds of voltage can be used as DCIN voltage. The DCIN voltage of one rack-mounted server has only to be the same as the DCIN voltage of the other rack-mounted server chained with one rack-mounted server using a power connection cable. Moreover, STBY voltage can be any DC voltage. The STBY voltage of one rack-mounted server has only to be the same as the STBY voltage of the other rack-mounted server chained with one rack-mounted server using a power connection cable. Furthermore, each of the power connection cables 115 and 125 includes a power bus sharing signal. Each of the power connection cables 115 and 125 may be designed such that power of all voltages can sufficiently flow therethrough, and the length thereof may be designed to minimize the length thereof in consideration of minimizing current loss.

In the power redundancy apparatus configured as shown in FIG. 1 in accordance with the present invention, when power fails in the first PSU 112, the first rack-mounted server 110 is supplied with necessary operating power through the power connection cable 115 from the second PSU 122 mounted in the second rack-mounted server 120 adjacent to the first rack-mounted server 110. When power fails in the second PSU 122, the second rack-mounted server 120 is supplied with necessary operating power through the power connection cable 115 from the first PSU 112 mounted in the first rack-mounted server 110 adjacent to the second rack-mounted server 120 or through the power connection cable 125 from the third PSU 132 mounted in the third rack-mounted server 130 adjacent to the second rack-mounted server 120. When power fails in the third PSU 132, the third rack-mounted server 130 is supplied with necessary operating power through the power connection cable 125 from the second PSU 122 mounted in the second rack-mounted server 120 adjacent to the third rack-mounted server 130.

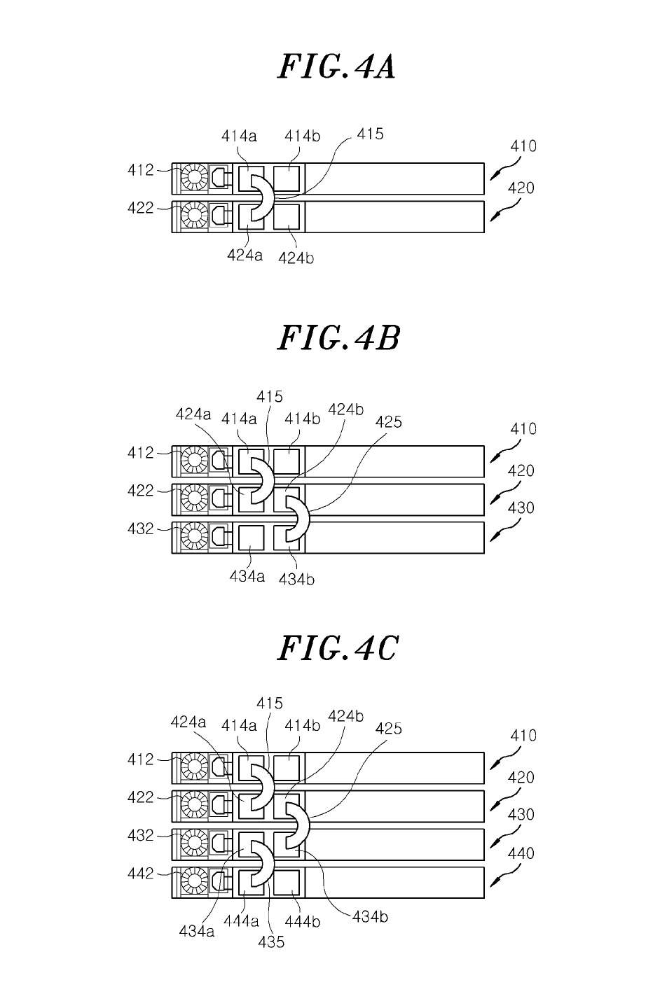

FIGS. 4a to 4c are diagrams showing examples in which the power redundancy apparatus in accordance with the present invention is applied to a different number of rack-mounted servers for a power supply redundancy mode.

Referring to FIG. 4a, a power redundancy apparatus in accordance with the present embodiment has an arrangement structure in which two first and second rack-mounted servers 410 and 420 are chained by a power connection cable (i.e., configured to share the power connection bus). The first rack-mounted server 410, which is equipped with a first PSU 412 and two connectors 414a and 414b, and the second rack-mounted server 420, which is equipped with a second PSU 422 and two connectors 424a and 424b, are chained by a power connection cable 415. In this structure, the power redundancy apparatus operates in a 1+1 power redundant mode. Here, the first and the second PSUs of the first and the second rack-mounted servers have the same maximum consumption power and the same capacity.

For example, if the capacity P_{PSU} of the PSU is twice as great as the maximum consumption power P_{S}_{_{—}}_{MAX} of the rack-mounted server (i.e., P_{PSU}>2*P_{S}_{_{—}}_{MAX}) , the power connection cable 415 can be coupled with the two rack-mounted servers 410 and 420 in order to form a 1+1 power redundancy structure. In this case, even if one PSU fails, the two rack-mounted servers operate using power supplied by the other PSU.

Referring to FIG. 4b, a power redundancy apparatus in accordance with the present invention shows an arrangement structure in which three first to third rack-mounted servers 410, 420, and 430 are chained by power connection cables (i.e., configured to share the power connection buses). The first rack-mounted server 410, which is equipped with a first PSU 412 and two connectors 414a and 414b, and the second rack-mounted server 420, which is equipped with a second PSU 422 and two connectors 424a and 424b, are chained by a power connection cable 415, and the third rack-mounted server 430, which is equipped with a third PSU 432 and two connectors 434a and 434b, is chained with the second rack-mounted server 420 by way of a power connection cable 425. In this structure, the power redundancy apparatus operates in a 2+1 power redundant mode. Here, the PSUs of the first to the third rack-mounted servers have the same maximum consumption power and the same capacity.

For example, if two times the capacity P_{PSU} of each PSU is greater than three times the maximum consumption power P_{S}_{_{—}}_{MAX} of each rack-mounted server (i.e., 2*Pₚ_{PSU}>3*P_{S}_{_{—}}_{MAX}), a 1+2 power redundancy structure can be configured by coupling the power connection cables 415 and 425 with the three rack-mounted servers 410, 420, and 430. In this case, even if one of the three PSUs fails, the three rack-mounted servers can operate using power supplied by the remaining two PSUs.

Referring to FIG. 4c, a power redundancy apparatus in accordance with the present invention has an arrangement structure in which four first to fourth rack-mounted servers 410, 420, 430, and 440 are chained by power connection cables (i.e., configured to share the power connection buses). The first rack-mounted server 410, which is equipped with a first PSU 412 and the two connectors 414a and 414b, and the second rack-mounted server 420, which is equipped with a second PSU 422 and two connectors 424a and 424b, are chained by a power connection cable 415. The third rack-mounted server 430, which is equipped with a third PSU 432 and two connectors 434a and 434b, is chained with the second rack-mounted server 420 by way of a power connection cable 425. The fourth rack-mounted server 440, which is equipped with a fourth PSU 442 and two connectors 444a and 444b, is chained with the third rack-mounted server 430 by way of a power connection cable 435. In this structure, the power redundancy apparatus operates in a 3+1 power redundant mode. Here, the PSUs of the first to the fourth rack-mounted servers have the same maximum consumption power and the same capacity.

For example, if three times the capacity P_{PSU} of each PSU is greater than four times the maximum consumption power P_{S}_{_{—}}_{MAX} of each server (i.e., 3*P_{PSU}>4*P_{S}_{_{—}}_{MAX}), a 1+3 power redundancy structure can be configured by coupling the power connection cables 415, 425, and 435 with the three rack-mounted servers 410, 420, 430, and 440. In this case, even if one of the three PSUs fails, the four rack-mounted servers can operate using power supplied by the remaining three PSUs. Here, the power redundancy apparatus can include 5 or more servers. The server power redundancy structure can be configured likewise.

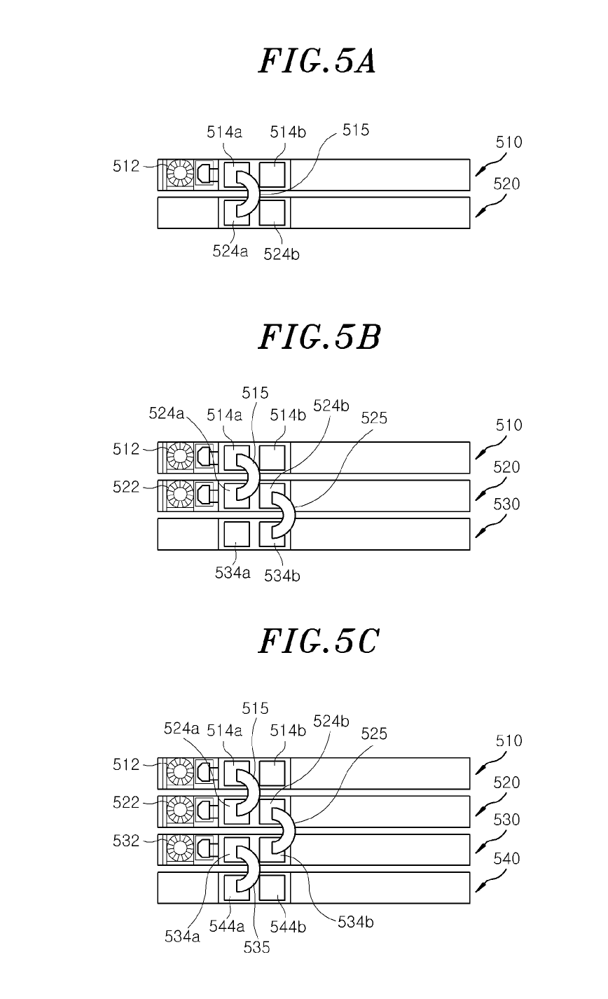

FIGS. 5a to 5c are diagrams showing examples in which the power redundancy apparatus in accordance with the present invention is applied to various numbers of rack-mounted servers for a high-efficiency mode.

The power redundancy apparatus in accordance with the present invention can be configured in a high-efficiency operating mode in addition to a supplementary power operating mode. In the high-efficiency operating mode, a supplementary power function is not provided, but the number of PSUs can be reduced and excellent power efficiency can be realized because the PSU can operate with high efficiency.

Referring to FIG. 5a, if p_{PSU}>2*P_{S}_{_{—}}_{MAX}, two first and second rack-mounted servers 510 and 520 can be coupled by a power connection cable 515, and only one PSU can be used.

More particularly, in the power redundancy apparatus in accordance with the present invention, the first rack-mounted server 510 is equipped with a first PSU 512 and two connectors 514a and 514b, and the second rack-mounted server 520 is equipped with only two connectors, 524a and 524b, without a PSU. Here, the connector 514a of the first rack-mounted server 510 and the connector 524a of the second rack-mounted server 520 are coupled by the power connection cable 515.

For example, if P_{PSU}>2*P_{S}_{_{—}}_{MAX}, the two rack-mounted servers 510 and 520 can operate using power supplied by one PSU by coupling the power connection cable 515 with the two rack-mounted servers 510 and 520 and installing the one PSU in any one of the two rack-mounted servers 510 and 520.

Referring to FIG. 5b, if 2*P_{PSU}>3*P_{S}_{_{—}}_{MAX}, three first to third rack-mounted servers 510, 520, and 530 can be coupled by power connection cables 515 and 525, and it is possible to use only two PSUs.

More particularly, in a power redundancy apparatus in accordance with the present invention, the first rack-mounted server 510 is equipped with a first PSU 512 and two connectors 514a and 514b, the second rack-mounted server 520 is equipped with a second PSU 522 and two connectors 524a and 524b, and the third rack-mounted server 530 is equipped with two connectors, 534a and 534b, without a PSU. Here, the connector 514a of the first rack-mounted server 510 and the connector 524a of the second rack-mounted server 520 are coupled by the power connection cable 515, and the connector 524b of the second rack-mounted server 520 and the connector 534b of the third rack-mounted server 530 are coupled by the power connection cable 525.

For example, if 2*P_{PSU}>3*P_{S}_{_{—}}_{MAX}, the three rack-mounted servers can operate using power supplied by two PSUs by coupling the power connection cables 515 and 525 with the three rack-mounted servers 510, 520, and 530 and installing only the two PSUs in only two of the three rack-mounted servers 510, 520, and 530.

Referring to FIG. 5c, if 3*P_{PSU}>4*P_{S}_{_{—}}_{MAX}, four first to fourth rack-mounted servers 510, 520, 530, and 540 can be coupled by power connection cables 515, 525, and 535 and it is possible to use only three PSUs.

More particularly, in a power redundancy apparatus in accordance with the present invention, the first rack-mounted server 510 is equipped with a first PSU 512 and two connectors 514a and 514b, the second rack-mounted server 520 is equipped with a second PSU 522 and two connectors 524a and 524b, the third rack-mounted server 530 is equipped with a third PSU 532 and two connectors 534a and 534b, and the fourth rack-mounted server 540 is equipped with only two connectors, 544a and 544b, without a PSU. Here, the connector 514a of the first rack-mounted server 510 and the connector 524a of the second rack-mounted server 520 are coupled by the power connection cable 515, the connector 524b of the second rack-mounted server 520 and the connector 534b of the third rack-mounted server 530 are coupled by the power connection cable 525, and the connector 534a of the third rack-mounted server 530 and the connector 544a of the fourth rack-mounted server 540 are coupled by the power connection cable 535.

For example, if 3*P_{PSU}>4*P_{S}_{_{—}}_{MAX}, the four rack-mounted servers can operate using power supplied by three PSUs by coupling the power connection cables 515, 525, and 535 with the four rack-mounted servers 510, 520, 530, and 540 and installing only three PSUs in three of the four rack-mounted servers.

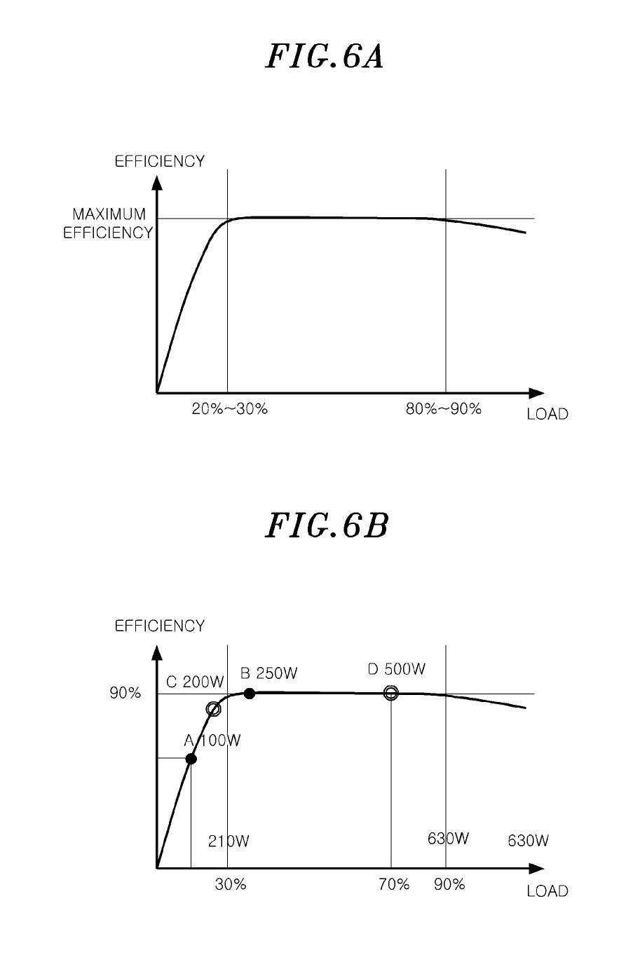

FIGS. 6a and 6b are graphs showing the results of a comparison between load-efficiency operating points in a common server and a high-efficiency mode server.

FIG. 6a shows a load-efficiency curve in a common PSU. From FIG. 6a, it can be seen that maximum efficiency appears in a range of 20%˜30% to 80%˜90% of a maximum load of the common PSU, a section below 20% to 30% has low efficiency, and in particular, a section below 10% has very low efficiency.

FIG. 6b shows an example of a common 1U server in which the reduction of efficiency is not great in a section over 70%˜90% in order to illustrate a high-efficiency operating mode. In this case, the PSU has a capacity of 700 W, no-load power consumption is 100 W, and the maximum consumption power of the server is 250 W. Here, the common 1U server has efficiency between a point A and a point B. That is, it can be seen that operating efficiency is not high in the case of a maximum load. In contrast, if a power redundancy apparatus is operated in a high efficiency mode by installing one PSU in two rack-mounted servers in accordance with the present invention, the power redundancy apparatus has efficiency between a point C and a point D. That is, the cost of supplying power can be reduced because a rack-mounted server operates with the highest power efficiency.

In general, assuming that 30 1U servers are mounted in a standard rack and the present invention is used, the installation cost of about 30 PSUs per rack and the power consumption of about 300 W to 1 kW (assuming that additional power consumption per server due to 30* power redundancy is several tens of watts) can be reduced.

Furthermore, if a server operates in a high-efficiency operating mode, in which a power redundancy function is not used, the present invention has the following advantages compared with an existing server that does not providing power redundancy (assuming that one PSU is mounted in the server).

First, the installation cost for the PSU can be reduced to ½ (P_{PSU}>2*P_{S}_{_{—}}_{MAX}), ⅓ (2*P_{PSU}>3*P_{S}_{_{—}}_{MAX}), or ¼ (½ (3*P_{PSU}>4*P_{S}_{_{—}}_{MAX})).

Second, the power necessary to drive a rack-mounted server can be reduced because the rack-mounted server is controlled so that it always operates at a high efficiency point in a high-efficiency operating mode.

In accordance with the present invention, two connectors coupled in parallel to the outside of a PSU are used in each rack-mounted server, and the connectors of two adjacent rack-mounted servers are coupled by a power connection cable. Accordingly, power redundancy can be realized even without an additional PSU and power can be stably supplied because the PSU of the other rack-mounted server supplies power even if the PSU of one rack-mounted server fails.

Furthermore, the cost for the power of a rack-mounted server can be reduced by reducing the reduction in power efficiency due to power redundancy.

While the invention has been shown and described with respect to the preferred embodiments, the present invention is not limited thereto. It will be understood by those skilled in the art that various changes and modifications may be made without departing from the scope of the invention as defined in the following claims.

What is claimed is:

1. A power redundancy apparatus for a rack-mounted server on which a plurality of servers is freely loaded, comprising:
a first server that includes first and second connectors connected in parallel to an output side of a first Power Supply Unit (PSU);
a second server that includes third and fourth connectors connected in parallel to an output side of a second PSU; and
a power connection cable for coupling any of the following combinations: the first and the third connectors, the second and the fourth connectors, the first and the fourth connectors, and the second and the third connectors.

2. The power redundancy apparatus of claim 1, wherein the first server comprises:
the first PSU;
a first power backplane board equipped with the first and the second connectors; and
a first server main board, on which a main PCB driven by power supplied by the first PSU or the second PSU is mounted.

3. The power redundancy apparatus of claim 2, wherein the first power backplane board couples an input signal, a control signal, and a load sharing signal between the first and the second servers in parallel.

4. The power redundancy apparatus of claim 1, wherein the second server comprises:
the second PSU;
a second power backplane board equipped with the third and the fourth connectors; and
a second server main board on which a main PCB driven by power supplied by the second PSU or the first PSU is mounted.

5. The power redundancy apparatus of claim 4, wherein the second power backplane board couples an input signal, a control signal, and a load sharing signal in parallel between the first and the second servers.

6. The power redundancy apparatus of claim 1, wherein the power connection cable couples any one of the first and the third connectors, the second and the fourth connectors, the first and the fourth connectors, and the second and the third connectors in a plug-in form.

7. A power redundancy apparatus for a rack-mounted server on which a plurality of servers is freely loaded, comprising:
a first server that includes first and second connectors connected in parallel to an output side of a first Power Supply Unit (PSU);
a second server that includes third and fourth connectors; and
a power connection cable for coupling any of the following combinations: the first and the third connectors, the second and the fourth connectors, the first and the fourth connectors, and the second and the third connectors.

8. The power redundancy apparatus of claim 7, wherein the first server comprises:
the first PSU;
a first power backplane board equipped with the first and the second connectors; and
a first server main board on which a main PCB driven by power supplied by the first PSU is mounted.

9. The power redundancy apparatus of claim 8, wherein the first power backplane board couples an input signal, a control signal, and a load sharing signal in parallel between the first and the second servers.

10. The power redundancy apparatus of claim 7, wherein the second server comprises:
a second power backplane board equipped with the third and the fourth connectors; and
a second server main board on which a main PCB driven by power supplied by the first PSU is mounted.

11. The power redundancy apparatus of claim 10, wherein the second power backplane board couples an input signal, a control signal, and a load sharing signal in parallel between the first and the second servers.

12. The power redundancy apparatus of claim 7, wherein the power connection cable couples any one of the first and the third connectors, the second and the fourth connectors, the first and the fourth connectors, and the second and the third connectors in a plug-in form.
